(19) United States
(12) Patent Application Publication
(10) Pub. No.: US 2006/0036536 A1
(43) Pub. Date: Feb. 16, 2006

(54) System and methods for evaluating the quality of and improving the delivery of medical diagnostic testing services

(76) Inventors: William R. Williams, Largo, FL (US); Denise A. Cottrill, Brandon, FL (US); Scott C. Farquhar, Zephyrhills, FL (US); Gary Mahoski, Tampa, FL (US); Katha Raulston, Nashville, TN (US); Kathe Russell, Land o' Lakes, FL (US)

Correspondence Address: BROWN, RAYSMAN, MILLSTEIN, FELDER & STEINER LLP, 900 THIRD AVENUE, NEW YORK, NY, 10022, US

(21) Appl. No.: 11/056,786

(22) Filed: Feb. 11, 2005

Related U.S. Application Data
(63) Continuation of application No. 11/027,780, filed on Dec. 30, 2004, now abandoned.
(60) Provisional application No. 60/533,137, filed on Dec. 30, 2003.

(51) Int. Cl. G06Q 40/00

(52) U.S. Cl. 705/38; 705/40

(57) ABSTRACT

Systems and methods may be utilized to obtain and evaluate data from various information resources associated with a diagnostic testing business for the purpose of identifying at-risk clients. A set of risk indicators is defined. Each risk indicator relates to a type of event that is determined to be indicative of client risk, and about which data may be obtained from information resources associated with the testing process. Data is obtained from the various information resources through respective interfaces and is stored in a risk indicator database. A reporting application associated with the risk indicator database applies score generation rules to the risk indicator data associated with each risk indicator to generate a risk score associated with each risk indicator for each client. The risk scores may then be evaluated to identify at-risk clients and to identify systemic problems of the organization that occur across many clients.

Applicant(s) hereby claim the benefit of provisional patent application Ser. No. 60/533,137, entitled “SYSTEM AND METHODS FOR EVALUATING THE QUALITY OF AND IMPROVING THE DELIVERY OF MEDICAL DIAGNOSTIC TESTING SERVICES,” filed Dec. 30, 2003, attorney docket no. 6597/6PROV.

### COPYRIGHT NOTICE

A portion of the disclosure of this patent document contains material which is subject to copyright protection. The copyright owner has no objection to the facsimile reproduction by anyone of the patent document or the patent disclosures, as it appears in the Patent and Trademark Office patent files or records, but otherwise reserves all copyright rights whatsoever.

### BACKGROUND OF THE INVENTION

1. Field of the invention

Preferred embodiments of the invention relate to diagnostic testing services and in particular to the gathering and evaluation of data for identifying at-risk clients of a testing service.

2. Related Technology

Medical diagnostic testing services are an essential component of healthcare. Physicians and other healthcare practitioners routinely prescribe various tests to assist in the diagnosis of patient conditions and to monitor their progress.

The testing process typically involves a standard series of events as illustrated in FIG. 1. Initially a specimen to be tested is collected 10. The specimen is then transported 12 to a testing facility. At the testing facility, the specimen is processed 14, which typically includes entering a variety of information into a computer system including the test to be performed, patient identification, the requesting doctor/hospital and insurance information. Processing 14 may also involve dividing the specimen into units for testing (referred to as alloquating). After processing 14 the specimens are tested 16. The test results are then reported 18, either electronically or in printed form, and billing and collection 20 for the cost of the testing are begun.

The events of the testing process typically involve a large number of facilities and information resources such as computer systems, computer applications and data stores. FIG. 2 illustrates examples of such facilities and information resources, with facilities shown in solid lines and information resources shown in broken lines. As seen in FIG. 2, requisitions for medical testing services are typically provided to a patient by a healthcare provider such as a physician or other practitioner at the location of the healthcare provider. The patient then provides a specimen for testing. The specimen may be provided at the healthcare provider's facility 22, or may be provided at a dedicated patient service center (PSC) 24. In either case, the specimen and requisition are transported by courier to a testing facility 26. At the testing facility, the specimen is received and processed by a specimen management department 28, which includes entering information about the specimen and requisition into a lab information system 32. The specimen is then forwarded to one or more testing departments 30 where specific tests are performed. After the tests are performed, results information is entered into the lab information system 32. Results are reported from the lab information system 32 in electronic or hardcopy form. Billing information is also generated by a billing system 34 that interfaces with the lab information system 32. The billing system 34 includes a payer requestor application 36 for generating and managing bills.

Several other information resources may also be used in relation to the services provided by the testing facility. A supply purchasing system 38 may be used by healthcare provider facilities such as physician's offices and patient service centers to obtain supplies that are needed for obtaining, storing and transporting specimens. A call center system 40 may be used by call center personnel in managing calls from clients reporting and seeking correction of problems regarding tests, billing, information technology and other issues. The call center system typically includes a problem tracking application 42 to track the reporting and resolution of certain types of problems. The problem tracking application 42 typically interfaces with the lab information system 32 to enable call center personnel to track problems related to specific test orders. A sales representative system 44 is typically used to track the appointments and actions of sales representatives who visit clients on behalf of the testing facility. A client survey system 46 may also be used to track client responses to quarterly surveys requesting information about the quality of service that the client is receiving. Management of the testing facility may also utilize various management applications such as a requisition volume tracking application 48 for tracking client requisition volumes, and a results tracking application 50 for tracking instances in which changes are required to be made to test result reports.

In this type of enterprise there is the potential for many types of events that could influence the client to use the services of a competitor. In order to maximize client retention, the test facility strives to minimize the number of such events. However, due to the complexity of the system and the high volume of specimens being processed, it is difficult to identify such events in real-time or evaluate trends with respect to individual clients for the testing facility as a whole. It is therefore in the interest of the testing facility to use all available information to identify such events and their causes, and to proactively address problems so that client attrition is minimized. As seen in FIG. 2, there are many information resources that are associated with the testing facility, and these may hold information that would be useful in identifying problems and improving service. However, these systems are not integrated, and are typically used by a variety of different entities both internal and external to the testing provider. Therefore it is difficult to identify and collect useful information that may be contained within each system. Further, the amount of relevant information may be large, requiring significant effort to compile and evaluate. The importance of various types of data may also vary depending on a number of factors, and so the data obtained from the various systems must be normalized in some manner so that the relative importance of each type of information can be determined and examined within the context of all available information.

### SUMMARY OF THE INVENTION

Preferred embodiments of the present invention are directed to systems and methods that may be utilized to obtain and evaluate data from various information resources associated with the diagnostic testing process for the purpose of identifying at-risk clients. In accordance with these embodiments, a set of risk indicators is defined. Each risk indicator relates to a type of event that is determined to be indicative of client risk, and about which data may be obtained from information resources associated with the testing process. Data is obtained from the various information resources through respective interfaces and is stored in a risk indicator database. A reporting application associated with the risk indicator database applies score generation rules to the risk indicator data associated with each risk indicator to generate a risk score associated with each risk indicator for each client. The risk scores may then be evaluated to identify at-risk clients and to identify systemic problems of the organization that occur across many clients.

Using systems and methods in accordance with the preferred embodiments of the invention, a testing provider may periodically evaluate the risk scores for each of its clients using risk indicator data obtained for a given reporting period, and may perform business processes to proactively address the sources of risk and resolve client issues.

While preferred embodiments of the invention are implemented in the context of the field of diagnostic testing, alternative embodiments may be implemented for other types of services using appropriately defined risk indicators.

### DESCRIPTION OF THE DRAWINGS

FIG. 1 shows events occurring in a typical diagnostic testing process.

FIG. 2 shows facilities and information resources associated with a typical diagnostic testing process.

FIG. 3 shows components of a system for collecting and evaluating risk indicator data in accordance with a preferred embodiment of the invention.

FIG. 4 shows the events illustrated in FIG. 1 and associated risk indicators used in the preferred embodiment.

FIG. 5 shows the risk indicators used in the preferred embodiment and data sources and score generation rules for the risk indicators.

FIG. 6 shows a scorecard report generated by the system of FIG. 3 in accordance with the preferred embodiment.

FIG. 7 shows a client report generated by the system of FIG. 3 in accordance with the preferred embodiment.

FIG. 8 shows a risk indicator report generated by the system of FIG. 3 in accordance with the preferred embodiment.

FIG. 9 shows a business processes utilizing the system of FIG. 3 and the reports of FIGS. 6 through 8 to identify and address at-risk clients.

FIG. 10 shows a user interface generated by the reporting application of the preferred embodiment for selecting risk indicators to be evaluated.

FIG. 11 shows a user interface generated by the reporting application of the preferred embodiment for specifying score generation rules associated with a particular risk indicator.

FIG. 12 shows a user interface generated by the reporting application of the preferred embodiment for specifying types of test not performed events to be included in test not performed risk indicators.

FIG. 13 shows a user interface generated by the reporting application of the preferred embodiment for specifying test in question events to be included in test in question risk indicators.

FIG. 14 shows a user interface generated by the reporting application of the preferred embodiment for specifying billing adjustment events to be included in a billing adjustment risk indicator.

FIG. 15 shows a user interface generated by the reporting application of the preferred embodiment for specifying senior leadership team members and attrition team members.

FIG. 16 shows a user interface generated by the reporting application of the preferred embodiment for specifying sales team members.

FIG. 17 shows a user interface generated by the reporting application of the preferred embodiment for creating standard email messages to be used for distributing copies of reports generated by the reporting application.

FIG. 18 shows a user interface generated by the reporting application of the preferred embodiment for running a process to create reports and for deleting risk indicator data from a risk indicator database.

### DETAILED DESCRIPTION OF PREFERRED EMBODIMENTS

According to one embodiment of the invention, a system is provided for identifying at risk clients of a business. The system comprises a risk indicator database for storing risk indicator data associated with risk indicators. One or more information resource interfaces obtain data from information resources associated with the business, and store the obtained data as risk indicator data in the risk indicator database. A reporting application is provided to apply score generation rules to risk indicator data from the risk indicator database to generate one or more risk indicator scores. Each risk indicator score represents an amount of risk of client loss corresponding to one or more associated risk indicators.

The reporting application may generate a total score for a client representing the sum of the risk indicator scores, or may generate a total score for each of a plurality of clients of the business. Similarly, the reporting application may be configured to specify one or more risk indicators to be evaluated by the reporting application, specify one or more events to be considered in generating a risk indicator score for a give risk indicator, or to specify the score generation rules to be applied to risk indicator data to generate a score for a given risk indicator. The reporting application may also generate reports according to a number of different configurations, including, but not limited to, reports showing one or more generated risk indicator scores for multiple clients of the business, or a specified client of the business. Those of skill in the art should appreciate the flexibility the system provides for determining the manner in which risk indicator scores are generated, including the inputs on which they are based and the manner in which they are reported.

According to another embodiment of the invention, a system is provided for identifying at-risk clients of a diagnostic testing business. The system comprises a risk indicator database containing data regarding events corresponding to one or more risk indicators, each risk indicator pertaining to a type of event that indicates a risk of client loss. One or more information resource interfaces obtain data from respective information resources associated with the diagnostic testing business; each information resource populates the risk indicator database. A reporting application applies score generation rules to the risk indicator data from the risk indicator database to generate, for a given client of the diagnostic testing business, a set of risk indicator scores each risk indicator score representing an amount of risk of client loss resulting from one or more events corresponding to one or more associated risk indicators.

The reporting application may be configured to specify one or more risk indicators to be evaluated by the reporting application. Furthermore, the reporting application may be configured to specify one or more types of events to be considered in generating a risk score for a given risk indicator. For example, specifying one or more types of test not performed events to be considered in generating a risk score for a test not performed risk indicator, one or more types of test in question events to be considered in generating a risk score for a test in question risk indicator, or one or more types of billing adjustment events to be considered in generating a risk score for a billing adjustment risk indicator. The reporting application may also be configurable to specify the score generation rules to be applied to the risk indicator data to generate a score for a given risk indicator.

The one or more information resource interfaces may include one or more interfaces, for example, an interface to a laboratory information system (e.g., for obtaining data related to test not performed events, test in question events and lost specimen events), a problem tracking application used by the diagnostic testing business (e.g., for obtaining data related to missed pickup events, missed test events, data entry errors at the testing facility, calls received at a call center that require follow-up with the client and calls received at a call center that do not require follow-up with the client), a call center application used at a call center (e.g., for obtaining data related to information technology issues), a sales representative system used by one or more sales representatives to record information concerning client visits (e.g., for obtaining data related to sales representative visits to clients and subjective assessments of client risk supplied by the sales representative), a supply purchasing system, a billing system (e.g., for obtaining data related to billing adjustments and missing information), a requisition volume tracking application (e.g., for obtaining data related to trends in client requisition volume) and a result tracking application (e.g., for obtaining data related to test result reports requiring revisions that change the interpretation of the test results.

The invention also contemplates methods for identifying at-risk clients of a business. According to one embodiment, the method comprises obtaining risk indicator data from information resource associated with the business, the risk indicator data related to one or more risk indicators, each risk indicator pertaining to a type of event that creates a risk of client lost. Score generation rules are applied to the risk indicator data to generate one or more risk indicator scores, each risk indicator score representing an amount of risk of client loss resulting from one or more events corresponding to one or more associated risk indicators. At-risk clients are identified based on the risk indicator scores associated with each client. The method may also comprise the steps of producing recommendations for addressing each at-risk client and entering the recommendations for each at-risk client into a score report for the at-risk client. Additional embodiments comprise the steps of providing the score report containing recommendations for the at-risk client to a sales team member responsible for the client, conducing a meeting between the sales team member and the client, and entering feedback from the sales team member regarding the meeting with the client into the score report for the client.

An alternative method of identifying at-risk clients of a business comprises the steps of obtaining risk indicator data from information resources associated with the business, the risk indicator data relating to one or more risk indicators and each risk indicator associated with a risk of client loss, applying score generation rules to the risk indicator data to generate one or more risk indicator scores each representing an amount of risk of client loss, and identifying an at-risk client based on the risk indicator scores.

According to another embodiment, a method for improving operation of a medical diagnostic testing service comprises the steps of obtaining risk indicator data from a plurality of different information resources associated with the service, the risk indicator data relating to one or more risk indicators and each risk indicator associated with a risk of client loss, applying score generation rules to the risk indicator data to generate risk indicator scores each representing an amount of risk of client loss corresponding to one or more associated risk indicators, and identifying systemic problems within the medical diagnostic service based on the risk indicator scores. The step of selecting risk indicators may include, e.g., selecting a missed pickup of specimens risk indicator or a performing the wrong test risk indicator.

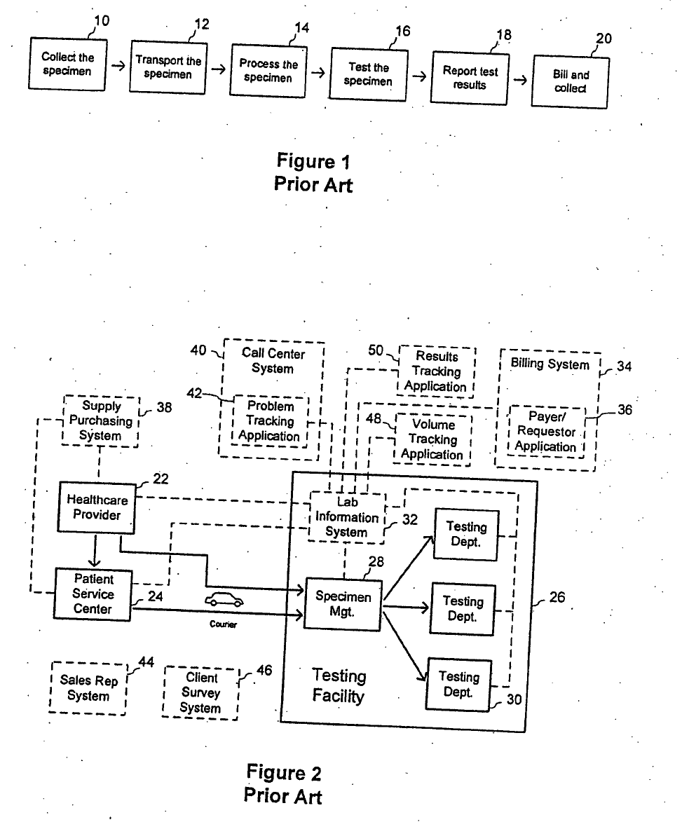

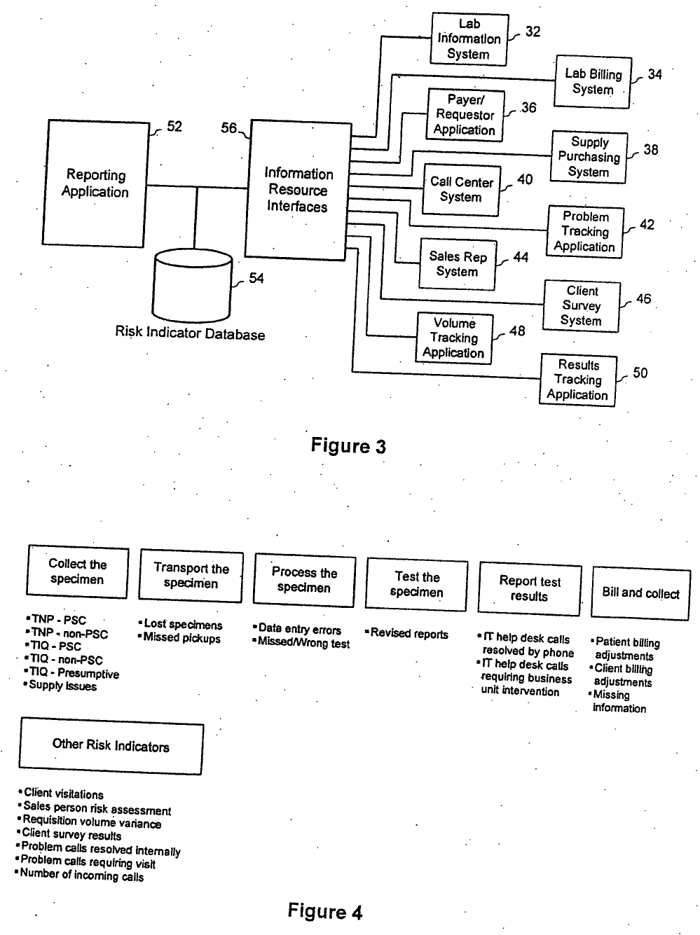

FIG. 3 is a high-level diagram showing components of a system in accordance with one preferred embodiment of the invention. The system obtains data from the various information resources shown in FIG. 2, and uses that data in evaluating risk indicators associated with the testing process. The system includes a reporting application 52, a risk indicator database 54, and information resource interfaces 56. The reporting application 52 is an end-user application that evaluates the risk indicator data to produce risk scores, and generates reports showing the risk scores and other relevant information. The reporting application 52 provides user interfaces that enable an administrator to configure the manner in which the system evaluates risk indicator data and the manner in which reports are distributed. The risk indicator data is obtained from the risk indicator database 54. The risk indicator database 54 is populated with data obtained from other information resources such as computer systems, computer applications and data stores by the information resource interfaces 56 that enable the system to access and extract data from various information resources that are related to the testing provider. As seen in FIG. 3, the preferred embodiment includes interfaces to each of the information resources illustrated in FIG. 2. A separate interface may be provided for each respective information resource to obtain specific types of data from that resource. The configuration of each interface will depend on the particular resource that it accesses, and the particular type of data obtained by each interface will depend on the data that is available from the information resource and the parameters of the risk indicators for which data is to be obtained. Typical interfaces may perform tasks such as accessing remote systems, querying databases, and reading data stores.

FIG. 4 shows risk indicators that are defined in a system in accordance with the preferred embodiment. In FIG. 4, sets of risk indicators are grouped with the testing process event with which they are most closely associated to indicate their relationship to the testing process. For example, with regard to transporting a specimen to the testing facility, the system defines two risk indicators: instances of lost specimens, and instances of missed pickups. In addition to risk indicators associated with specific events in the testing process, the preferred embodiment defines a further set of risk indicators which are independent of individual test process events, such as variations in the volume of test requisitions received from each client.

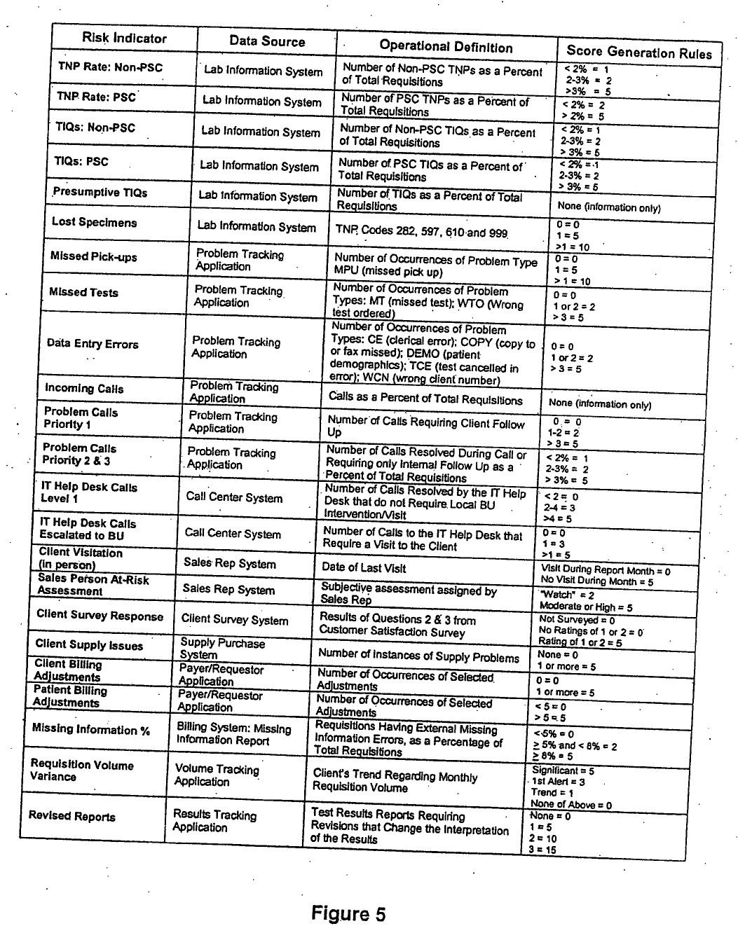

More detail about each of the risk indicators used in the preferred embodiment is provided in FIG. 5. For each risk indicator, FIG. 5 shows the name of the risk indicator, the data source (i.e. the information resource from which data that is relevant to the risk indicator is obtained), the operational definition of the risk indicator, and examples of score generation rules that may be used for the risk indicator. In FIG. 5 the risk indicators are arranged based on the information resource that serves as a data source for the risk indicator.

The first group of risk indicators shown in FIG. 5 use data obtained from the lab information system. These risk indicators include two “test not performed” (TNP) risk indicators. The first TNP risk indicator relates to the number of test not performed events for patients who did not give a specimen at a patient service center (PSC), as a percent of the client's non-PSC requisitions. The second TNP risk indicator relates to the number of test not performed events for patients who gave a specimen at a patient service center (PSC), as a percent of the client's PSC requisitions. The lab information system stores data for each requisition that indicates the type of any TNP event associated with the requisition. By comparing the score generation rules for the TNP risk indicators, it is seen that the rules assign a higher score risk to the TNPs that occur for PSC patients than to non-PSC patients. In other words, these rules represent the judgment that TNP errors are more likely to be expected for patients who did not provide a specimen at a patient service center, and therefore are less of a client irritant.

Three further risk indicators based on data from the lab information system relate to “test in question” (TIQ) events. A test in question event occurs when it is not clear which test or tests are to be performed from the requisition and specimen. This may occur, for example, when the requisition specifies a test using a name that is not used by the testing facility, or that could refer to one of several tests, or when a specimen is provided in a container that is not typically used for the type of test that has been requested. A first TIQ risk indicator relates to the number of test in question events for patients who did not give a specimen at a patient service center, as a percent of the client's non-PSC requisitions. A second TIQ risk indicator relates to the number of test in question events for patients who gave a specimen at a patient service center (PSC) as a percent of the client's PSC requisitions. A third TIQ risk indicator represents the number of presumptive TIQs as a percentage of total requisitions received by the testing facility. A presumptive TIQ is a TIQ event where the requested test can be surmised from the materials received, allowing the test to be conducted immediately although still requiring confirmation from the client. In contrast, the other TIQ risk indicators pertain to TIQ events that prevent performance of any test until clarification has been received from the client. The lab information system stores data for each requisition that indicates the type of any TIQ event associated with the requisition. By comparing the score generation rules for the first two TIQ risk indicators, it is seen that the rules assign equal scores to both types of TIQ events, reflecting a judgment that these risk indicators carry equal weight in the risk assessment process. It is also noted that no score generation rules are associated with the presumptive TIQ risk indicator. This represents a judgment that this risk indicator is not relevant to assessing client risk at this facility.

An additional risk indicator based on data from the lab information system relates to lost specimens. Instances of lost specimens are determined to have occurred whenever one of several predefined codes are associated with a requisition in the lab information system database. Scores are generated based on the number of the client's lost specimen events.

Another group of risk indicators use data obtained from the problem tracking application, which is used by personnel at a call center to track the resolution of problems reported by clients. The first three of these indicators relate to missed pickups, missed tests, and data entry errors. Instances of these three types of events are determined to have occurred whenever one of several predefined codes has been associated with a requisition in the problem tracking application, and scores are generated based on the number of each type of event experienced by the client. Other risk indicators that use data from the problem tracking application relate to the number and types of calls received for each client. An incoming calls risk indicator relates to the number of calls received as a percent of total requisitions for a given client. In the configuration shown in FIG. 5, no score generation rule is assigned to this risk indicator, representing a judgment that this risk indicator is not relevant to assessing client risk at this facility. A first problem calls risk indicator relates to the number of calls received from the client that required follow-up with the client to resolve. A second problem calls risk indicator relates to the number of calls received from the client that were resolved during the call or that required only internal follow-up to resolve. Codes entered into the problem tracking application indicate the occurrence of each of these types of calls. Scores are assigned for the first type of call based on the number of such calls, whereas scores are assigned for the second type of call based on the percentage of all calls for the client that fall into this category.

A set of risk indicators relating to client calls concerning information technology issues use data obtained from the call center system. A first of these risk indicators relates to the number of calls received from clients that were resolved without a visit to the client or other intervention from outside of the call center. A second of these risk indicators relates to the number of calls received from the client that required a visit to the client for their resolution. Codes entered into the call center system indicate the occurrence of each of these types of calls. The score generation rules for these risk indicators assign scores based on the number of such calls, and assign a higher score for calls that required visits to resolve.

Two further risk indicators use data obtained from the sales representative system. A first of these risk indicators relates to the date of the most recent visit to the client by a sales representative. A score of zero is assigned for this risk indicator so long as the client has been visited by a sales representative within the month for which the risk indicator is being evaluated, while the absence of a visit produces a score of five. A second of the risk indicators that use data from the sales representative system is a subjective risk assessment made by the sales representative for the client. The assessments are made using predefined risk assessment descriptions. Scores are generated for this risk indicator based on which of the predefined risk assessments the sales representative has selected for the client.

A client survey response risk indicator uses data obtained from the client survey system. This risk indicator relates to answers supplied by the client to two specific questions in a quarterly client survey. The first question asks the client to rate their level of satisfaction with the services provided by the testing facility. A score of one indicates low satisfaction, and a score of five indicates high satisfaction. The second question asks the client to rate the likelihood that the client will be using the services of the testing facility in year's time. A score of one indicates that this is unlikely, and a score five indicates that this is very likely. The score generation rules for this risk indicator assign scores based on whether either of the questions is answered with a one or a two.

A client supply risk indicator uses data obtained from the client's supply purchase system, and relates to client supply issues such as the client having insufficient supplies to store or ship a specimen. The score generation rules assign a score if one or more instances of this type of problem have occurred. In alternative implementations, the information for this risk indicator may be obtained from the problem tracking application.

Two further risk indicators use data obtained from the payer requestor application, and relate to billing adjustments. Billing adjustments occur, for example, when an incorrect billing rate is used on the initial bill, requiring the bill to be corrected and reissued. For purposes of these-risk indicators, billing adjustments are analyzed separately for patient bills that are sent directly from the testing facility to the patient, and for client bills that are sent from the testing facility to the client, who then bills the patient. The payer requestor application stores codes in association with requisitions that indicate the occurrence of various types of billing adjustments. The score generation rules assign scores based on the number of occurrences of adjustments.

A missing information risk indicator uses data obtained from a missing information report contained in the billing system. This risk indicator relates to the number of instances where the billing process was affected by missing information. Scores are assigned for this risk indicator based on the percentage of the client's requisitions that have missing information in the billing process.

A further risk indicator relates to requisition volume variance. The information for this risk indicator is obtained from a volume tracking application that obtains requisition the volume information from the lab information system, identifies trends in the monthly volume of each client's requisitions, and assigns one of various predefined identifiers to characterize any trend in the client's requisition volume. Scores are assigned for this risk indicator based on the appearance of various types of negative trend identifiers.

The final risk indicator relates to revised reports. The information for this risk indicator is obtained from a results tracking application that contains data indicating the number of test results reports that were required to be revised in a manner that changes the interpretation of the test results. The results tracking application stores information about each revised report for each client. Scores are assigned for this risk indicator based on the number of occurrences of revised reports during the reporting period.

The score generation rules associated with the risk indicators of FIG. 5 are used to generate risk scores for each risk indicator. The rules are defined in a manner that produces numerical scores that represent the relative importance of the type and number of risk indicator events that have occurred during the reporting period. In the preferred embodiment, a risk score scale of 0 to 15 is used. The score generation rules of FIG. 5 represent a judgment as to the relative importance of various types of events in assessing client risk. For example, under the rules used for the missing information risk indicator, the score of five is generated if more than 8% of all requisitions involve missing information events. In comparison, a score of five is assigned for the revised reports risk indicator if a single report has been revised. Similarly a score of five is assigned for the lost specimen and missed pickup risk indicators if a single instance of either type of event has occurred. This illustrates a judgment as to the risk created by lost specimens and missed pickups as compared to missing information events. As described below, the score generation rules may be configured to accurately reflect the judgment of the organization with regard to each risk indicator.

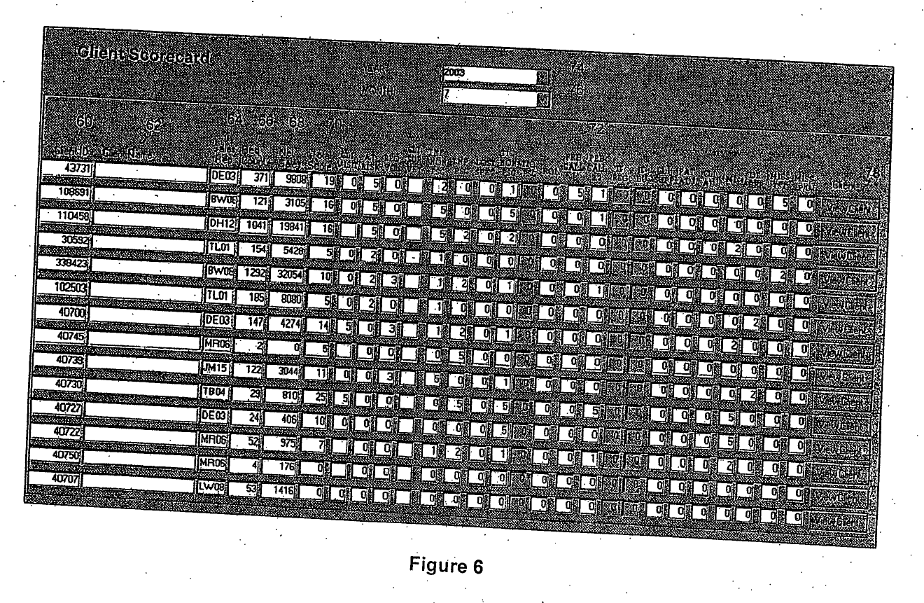

FIG. 6 shows an example of a client scorecard report generated by the reporting application 52 of the system shown in FIG. 3. The scorecard presents a list of clients along with information showing, for each client, the risk scores calculated for each risk indicator based on events occurring during the month of the report, and the total of all risk scores for each client. The scorecard is formatted as a table that includes client ID 60 and client name 62 fields for identifying each client in the table. A sales rep field 64 identifies the sales representative who is responsible for the client. A requisition count field 66 and a net sales field 68 show the number of requisitions and the net sales for that client during the reporting period. The total score field 70 shows the sum of all risk scores for all risk indicators during the reporting period. A set of risk indicator fields 72 to show the risk scores for each individual risk indicator for the client based on events occurring during the reporting period. The scores are calculated using the score generation rules for each risk indicator and the risk indicator data stored in the risk indicator database. Year 74 and month 76 fields provide pull-down lists that allow the user to select the month and year for which the scorecard is to be generated. The scorecard report enables the user to quickly identify those clients for which there may be significant risk of loss, i.e., risk of losing the client due to client dissatisfaction, and to identify the types of issues that may be most responsible for creating that risk. The report also enables the user to identify trends that are not localized to a single client. For example, the presence of significant data entry error risk scores for many clients would suggest that data entry errors are being made repeatedly at the facility's specimen management department.

It will be noted that the scorecard report of FIG. 6 does not include two of the risk indicators defined in FIG. 5, namely the Presumptive TIQ risk indicator and the Incoming Calls risk indicator. As indicated above, no score generation rules are associated with these risk indicators because by definition they are considered to provide information that is useful for the organization for a purpose other than risk assessment. Therefore these risk indicators are not included in the scorecard report. It will also be noted that there are no scores in the fields associated with the client survey risk indicator. This indicates that no data was produced for this risk indicator during the reporting period. In addition, it will also be noticed that fields for three of the risk indicators are grayed-out in the scorecard report, namely, the risk indicators for PSC TIQs and the two risk indicators relating to IT help desk calls. This indicates that the system has been configured to exclude these risk indicators from among the risk indicators that are evaluated for this facility, representing a judgment that these risk indicators are not useful for evaluating risk for clients of this facility. Configuration of the system to exclude risk indicators in this manner is discussed further below.

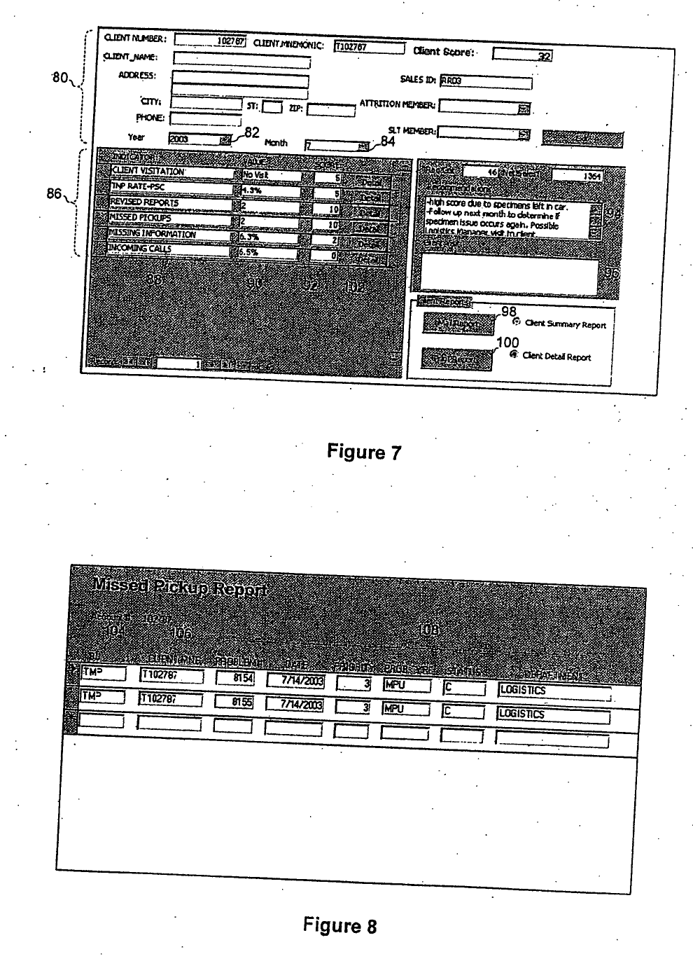

The scorecard report of FIG. 6 also includes a view client tool 78 associated with each client. The view client tool 78 generates the display of a client report that shows more specific information about each risk indicator that generated a risk score for the client. FIG. 7 shows an example of a client report. The report includes fields 80 for client demographic information, and year and month fields 82, 84 that allow the user to access a report for that client for any available month and year. A detail field 86 contains a table that includes fields showing each risk indicator 88 that generated a score for the client, the value 90 of the risk indicator, and the score 92 that was generated by the score generation rules based on the value of the risk indicator. For example, the client report shows the occurrence of two missed pick-up events, resulting in a score of 10 for the missed pickup risk indicator. The client report also includes a recommendations field 94 for displaying specific recommendations for addressing the various risk indicator events shown in the client report. The client report also includes a client visit field 96 for displaying information received from a sales representative who has visited the client to address the risk indicator events shown in the client report. The client report also includes an email report tool 98 that emails the report to personnel responsible for the relationship with the client, and a print report tool 100 that prints a copy of the client report. For each of these tools, the user may select whether to email or print a summary report or a detailed report that includes information about all risk indicators of events for the client.

Detailed information about events associated with any of the risk indicators shown in the client report can be accessed by using the detail tool 102 associated with that-risk indicator. FIG. 8 shows an example of a risk indicator report for the missed pickups risk indicator in the client report of FIG. 7. The risk indicator report for this risk indicator provides information concerning each event that contributed to the value for that-risk indicator and the resulting risk score. The risk indicator report includes a field identifying the business unit 104 of the testing facility, a field 106 identifying the client, and a set of fields 108 providing the data from the risk indicator database that relates to each risk indicator shown in the detail report. For example, the risk indicator report of FIG. 8 provides information concerning the two missed pickup events referenced in the client report of FIG. 7, including the date on which each missed pickup occurred. This report enables the user to view information about each event associated with the risk indicator to help in formulating recommendations for addressing these problems with the client.

While FIGS. 6, 7 and 8 show computer display versions of the scorecard report, client report and risk indicator report, the system preferably also provides printed versions of these reports.

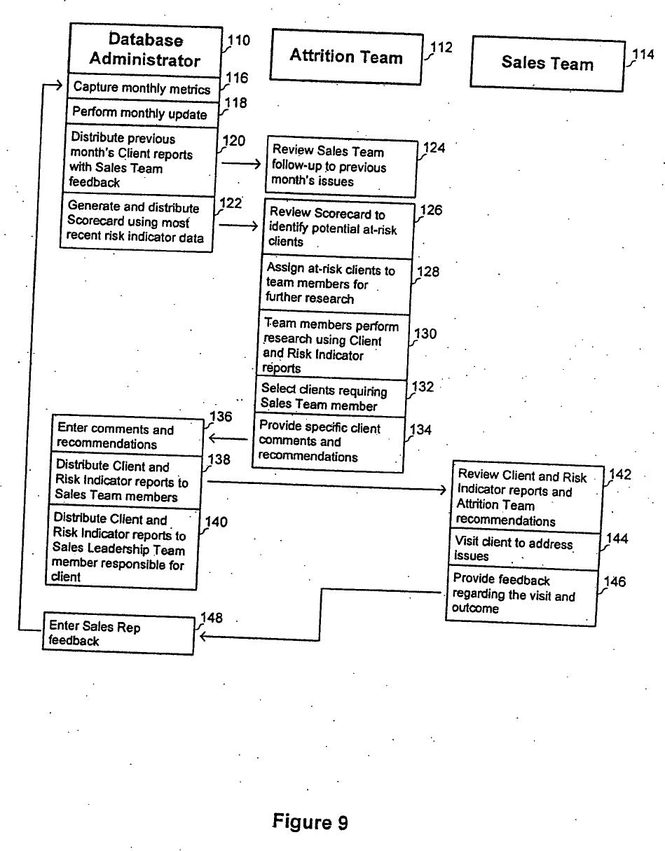

The scorecard report, the client report and the risk indicator report are preferably used in a business process for identifying at-risk clients and proactively addressing issues to reduce the risk associated with those clients. FIG. 9 provides a process flow diagram for a business process using these reports. The process is carried out among the three entities: a database administrator 110 who is responsible for updating and maintaining the risk indicator database, generating reports, and entering recommendations and feedback into client reports; an attrition team 112 whose members evaluate the risk indicators for individual clients and make recommendations concerning actions to be taken for that-risk clients; and a sales team 114 whose members are individually responsible for making contact with specific clients to carry out recommendations provided by the attrition team and to report results of those actions. As shown in process flow diagram of FIG. 9, the process is a cyclical process that is carried out monthly. For a given month, the database administrator captures monthly metrics 116 that characterize and confirm the usage of the system within the organization, including information such as the specific configurations used and confirmation of report generation and distribution. The database administrator then performs a monthly update 118 of the risk indicator database to populate the risk indicator database with the most recent information from the interfaced information resources. The database administrator then distributes 120 to attrition team members the previous month's client reports that contain feedback from sales team members responsive to recommendations made by the attrition team members. The attrition team is typically comprised of upper management personnel who are collectively referred to as the senior leadership team, and may include additional management personnel. Using the updated risk indicator data, the database administrator also generates and distributes 122 to attrition team members the scorecard report for the most recent month.

Upon receiving the previous month's client reports, the attrition team members review 124 those reports to ensure that proper actions were taken in response to their recommendations as indicated by the sales team member feedback that has been entered in the reports. The attrition team members then review the scorecard 126 for the current reporting period to identify clients that appear to be at-risk based on the risk indicator scores and overall scores for each client. Typically any client whose total risk score exceeds a predetermined threshold will be considered at-risk, however the at-risk threshold may be flexible, or specific combinations of risk indicator scores may be defined as placing the client at-risk. At-risk clients are assigned 128 to individual attrition team members, who perform further research 130 using the client and risk indicator reports for that client. Based on the research by the attrition team members, the attrition team selects clients who require intervention by a sales team member 132. Specific comments and recommendations are generated 134 for each of those clients and forwarded to the database administrator.

Upon receiving the individual client comments and recommendations from the attrition team, the database administrator enters the comments and recommendations 136 into the appropriate fields on the client reports. The database administrator then distributes 138 those client reports to the sales team members who are responsible for each client. The database administrator also distributes 140 a copy of each of the client reports to a senior leadership team member who is responsible for the client.

Upon receiving a client report with recommendations, the sales team member reviews 142 the client report, risk indicator reports, and attrition team recommendations. The sales team member then visits 144 the client to address the events reflected in the reports and to carry out the recommendations of the attrition team. Upon completing the visit, the sales team member provides feedback 146 regarding the client visit and its outcome. This feedback is forwarded to the database administrator, who enters the feedback 148 into appropriate fields in the client reports. The cycle may then be repeated, with the updated reports including sales team member feedback being reviewed by the attrition team, and a newly generated scorecard based on the most recent months data being reviewed by the attrition team members to identify at-risk clients based on risk indicator data for the current reporting period.

While the process illustrated in FIG. 9 focuses on identifying problems that are specific to individual clients, the process may also utilizes the scorecard to identify systemic performance issues by reviewing each risk indicator across all clients or selected subsets of clients.

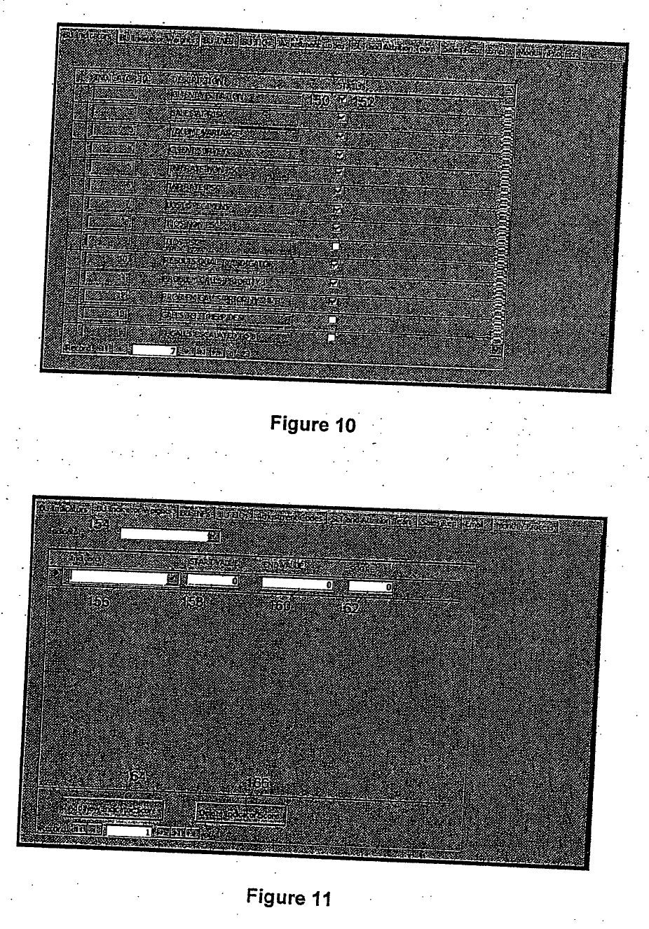

A number of the features of the reporting application of FIG. 3 are configurable by a system administrator. FIGS. 10 through 18 show user interfaces generated by the reporting application of FIG. 3 that allow a system administrator to configure the reporting application in accordance with the particular needs of the organization.

FIG. 10 shows a user interface generated by the reporting application for selecting the risk indicators that are to be evaluated for clients of the organization. The user interface presents a list of all risk indicators 150 that are defined in the system. A field 152 associated with each risk indicator may be checked to indicate that the risk indicator is to be evaluated. The decision regarding each risk indicator is typically based on a number of factors including availability of the data needed to evaluate the risk indicator, the reliability of that data, and the relevance of the risk indicator to clients of the organization.

FIG. 11 shows a user interface generated by the reporting application for configuring the score generation rules associated with each risk indicator. The user interface includes a pulldown list 154 for selecting a risk indicator for which all existing score generation rules will be displayed. A further pulldown list 156 is provided for selecting a risk indicator for which a ruled is to be created. Start value 158 and end value 160 fields are provided for entering the start and end values of a range of values associated with a particular score,. and a score field 162 is provided for entering the numerical score associated with that range. A new indicator score tool 164 and a delete indicator score tool 166 are provided to initiate the creation or deletion of score generation rules.

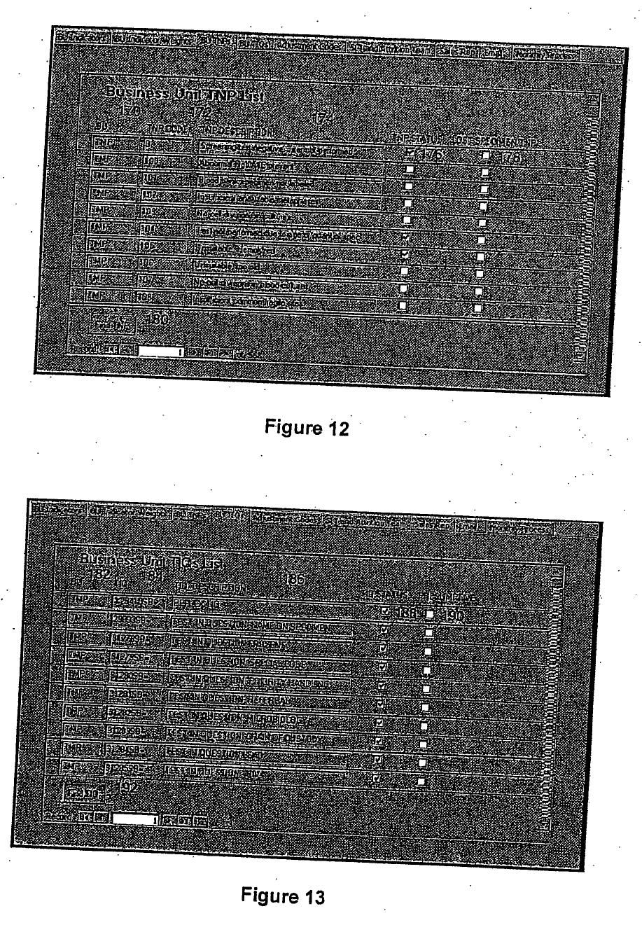

FIG. 12 shows a user interface generated by the reporting application for configuring the components of the test not performed risk indicators. The user interface includes business unit fields 170 that identify the business unit or units that use this TNP code. A TNP code field 172 and an associated TNP description field 174 list the identification codes and descriptions for various types of test not performed events. A status field 176 associated with each TNP event may be checked to indicate whether that TNP event is to be included among the TNP events evaluated for the TNP risk indicators. A lost specimen fields 178 associated with each TNP event may be checked to indicate those TNP codes that are used to indicate lost specimen events, and which are therefore evaluated separately from other TNP events. Consequently only one of the fields 176, 178 may be checked for each TNP event. A find TNP tool 180 allows the user to search for a specific TNP event.

FIG. 13 shows a user interface generated by the reporting application for configuring the components of the test in question risk indicators. The user interface includes business unit fields 182 that identify the business unit or units that use each TIQ code. A TIQ code field 184 and an associated TIQ description field 186 list the identification codes and descriptions of various types of test in question events. A status field 188 associated with each TIQ event may be checked to indicate whether that TIQ event is to be included among the TIQ events evaluated for the TIQ risk indicators. Presumptive fields 190 associated with each TIQ event may be checked to indicate TIQ events that are considered to be presumptive, and which are therefore evaluated separately from other TIQ events. Consequently, only one of the fields 188, 190 may be checked for each TIQ event. A find TIQ tool 192 allows the user to search for a specific TIQ event.

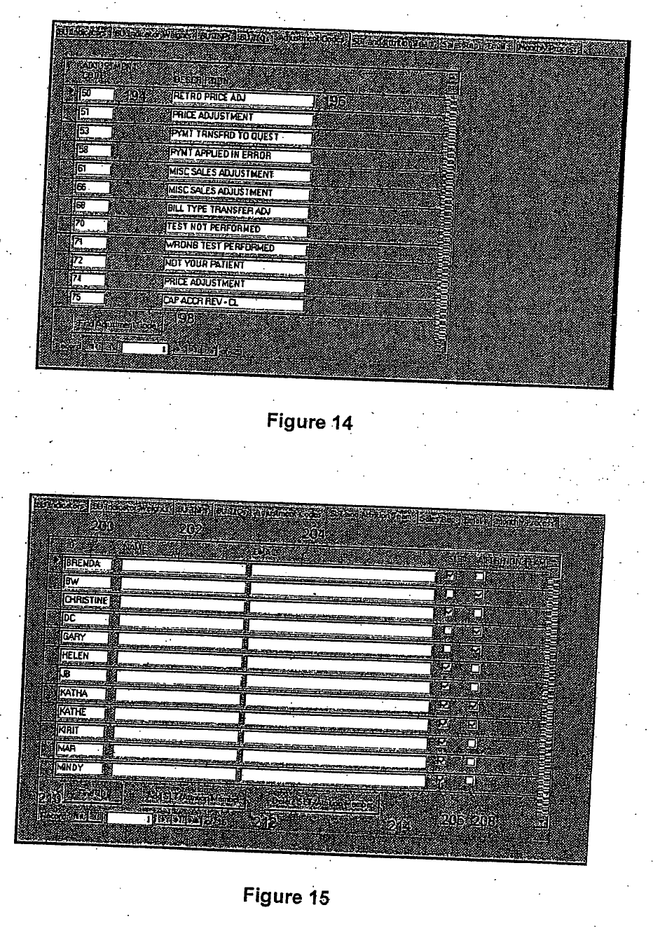

FIG. 14 shows a user interface generated by the reporting application for entering the identifiers and descriptions of types of billing adjustments that will be evaluated for the billing adjustment risk indicator. The specific billing adjustment descriptions and the codes that represent them in the risk indicator data will typically vary depending on the manner in which these adjustments are represented in the payer requester information system. Consequently, the user interface requires the user to specify codes and descriptions, rather than providing the user with a predefined list of codes to select from. The user interface includes adjustment code fields 194 and associated adjustment code description fields 196 for entering identifiers and descriptions of various types of billing adjustment. A find tool 198 enables the user to search the list for a particular adjustment.

FIG. 15 shows a user interface generated by the reporting application for specifying the members of the sales leadership team and the attrition team. The user interface includes ID 200, name 202, and email address 204 fields in which the 10s, names and email addresses of team members may be entered. An SLT field 206 and an attrition team field 208 associated with each individual may be checked to indicate whether that individual's membership in the senior leadership and attrition teams. Tools are provided in the user interface to find 210, add 212 and delete 214 team members. The information entered in these fields is used for email distribution of scorecards and client and risk indicator reports.

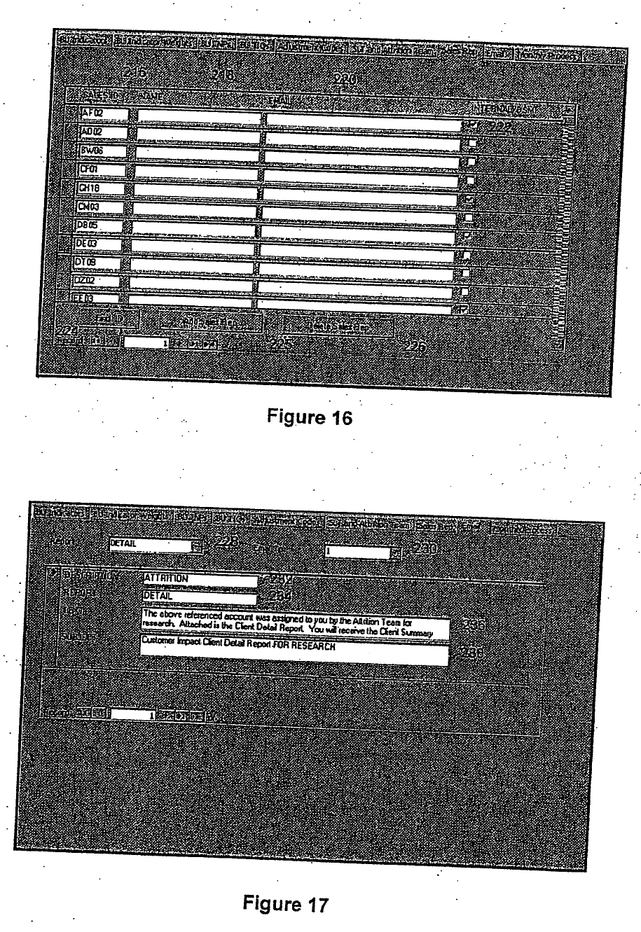

FIG. 16 shows a user interface generated by the reporting application for specifying sales team members. The user interface includes ID 216, name 218, and email address 220 fields in which the IDs, names and email addresses of sales team members may be entered. An internal field 222 associated with each sales team member may be checked to indicate whether the sales team member is classified as an internal sales team member. This criteria is used in evaluating the client visitation risk indicator, because clients assigned to internal sales team members do not require monthly visits. The user interface also provides tools for finding 224, adding 225 and deleting 226 team members. The information entered in the fields of this user interface is used for email distribution of client and risk indicator reports to sales team members.

FIG. 17 shows a user interface generated by the reporting application for creating standard email messages for use in distributing copies of reports. The user interface includes a report type field 228 for specifying the type of report that the email message will be used to distribute. The user interface also includes an email list field for selecting a mailing list to which the email will be distributed. The selection of a report type and mailing list automatically populates the contents of a description field 232 and a report field 234. The text of the email message may be entered in a text field 236, and the subject line of the email message may be entered in a subject field 238. This user interface allows the system administrator to create standard emails for use in reporting various reports to various groups of recipients in accordance with standard operating procedures.

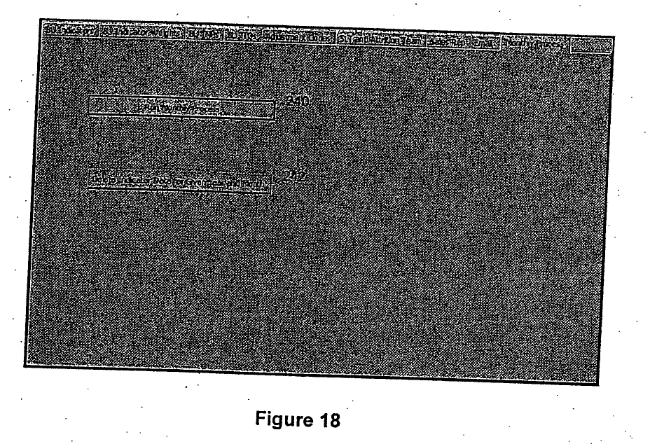

FIG. 18 shows a user interface generated by the reporting application for running a monthly process to generate a scorecard for the current reporting period using the most recent risk indicator data. A run monthly process tool 240 brings up a further user interface that includes fields for entering the year and month to be processed and a run monthly process button for initiating the process. The user interface of FIG. 18 also includes a delete tool 242 that brings up a further user interface allowing the system administrator to delete risk indicator data for a given year and month.

By using the user interfaces of FIGS. 10 through 18, the system administrator is enabled to select the risk indicators that will be included in a scorecard report, select the particular types of events that will be evaluated for certain risk indicators, specify the score generation rules associated with each risk indicator, and specify the various individuals who will receive copies of reports generated by the system and their roles.

While the foregoing description is specific to a preferred embodiment of the invention, a variety of alternatives may be implemented. The preferred embodiment is designed for an organization that includes multiple testing facilities, with the organization being divided into business units corresponding to individual regions or testing facilities, and the reporting application being configured independently by each business unit. However, alternative embodiments of the invention may be implemented for organizations that comprise a single testing facility or business unit, and the organization may utilize a single configuration for the entire organization, or multiple configurations may be utilized by the organization or its individual business units.

The configurability of the system may also be modified depending on the needs of the organization. For example, a while the preferred embodiment permits selection of risk indicators that will be used for all clients of the business units, alternative embodiments may allow risk indicators to be selected for individual clients. Similarly, while the preferred embodiment permits selection of events to be included in certain risk indicators for all clients of the business unit, alternative embodiments may allow risk indicator events to be selected for individual clients. Further alternative embodiments may also allow score generation rules to be configured for individual clients.

Further, while the preferred embodiment uses predefined risk indicators that use hard-coded interfaces to obtain the required risk indicator data, alternative embodiments may include development tools that enable the system administrator to create further risk indicators by developing interfaces for obtaining the required risk indicator data from external systems, and to expanding the risk indicator database to include new types of risk indicator data.

The business processes associated with the system of the preferred embodiment may also be tailored to the needs of various types of organizations. For example, while the preferred embodiment is designed for an organization comprised of attrition and sales teams comprised of distinct members, in alternative embodiments the roles of attrition team and sales team members may be performed by the same individuals. The roles of the database administrator may also be performed by individuals who perform attrition team or sales team roles. Further, while the preferred embodiment performs risk score analysis on a monthly basis, alternative embodiments may employ a different reporting period that is more appropriate for the type of service and clients for which the risk assessment is being performed.

The invention may be embodied in the device is used to implement the system illustrated in FIG. 3 and alternative implementations. Such devices are typically programmable devices for that operate under the control of programming code stored in a computer readable media that is accessible by the device. The invention may also be embodied in processes performed by such devices, the computer readable media storing programming code for controlling those devices, and in systems utilizing such devices or performing such processes. The invention may also be embodied in business processes performed by individuals in a business organization using such systems and devices.

While the systems and methods of the preferred embodiment are presented in the context of assessing client risk for a medical diagnostic testing organization, alternative embodiments may be implemented for organizations that provide other types of services. In such implementations, a different set of risk indicators may be defined to represent types of events that create client risk in the context of the particular services being provided and the particular types of clients been served. Interfaces to information resources may be created to obtain risk indicator data that is relevant to each of the risk indicators, and the risk indicator data obtained by the interfaces may be used to populate a risk indicator database. The data in the risk indicator database may then be used by a reporting application to calculate risk score is associated with each risk indicator based on the events represented in the risk indicator database, and these scores may be used to identify and address at-risk clients.

The devices, features and processes described herein are not exclusive of other devices, features and processes, and variations and additions may be implemented in accordance with the particular objectives to be achieved. For example, a system as described above may be integrated with other systems not described herein to provide further combinations of features, to operate concurrently on the same computing devices, or to serve other types of users. Thus, while the embodiments illustrated in the figures and described above are presently preferred for various reasons as described herein, it should be understood that these embodiments are offered by way of example only. The invention is not limited to a particular embodiment, but extends to various modifications, combinations, and permutations that fall within the scope of the claims and their equivalents.

What is claimed is:

1. A system for identifying at-risk clients of a business, comprising:
a risk indicator database for storing risk indicator data associated with risk indicators;
one or more information resource interfaces that obtain data from information resources associated with the business and store the obtained data as risk indicator data in the risk indicator database; and
a reporting application that applies score generation rules to the risk indicator data from the risk indicator database to generate one or more risk indicator scores representing amounts of risk of client loss corresponding to associated ones of the risk indicators.
